(19) United States
(12) Patent Application Publication
(10) Pub. No.: US 2009/0200284 A1
(43) Pub. Date: Aug. 13, 2009

(54) CABLE CASTING FOR THE GUIDANCE OF A WIRE

(76) Inventor: Lionel Sanchez, Til-Chatel (FR)

Correspondence Address: CLARK & BRODY, 1090 VERMONT AVENUE, NW, SUITE 250, WASHINGTON, DC, 20005, US

(21) Appl. No.: 11/989,120

(22) PCT Filed: Jul. 20, 2006
(86) PCT No.: PCT/FR2006/050738

§ 371 Date: Apr. 3, 2009

(30) Foreign Application Priority Data
Jul. 22, 2005 (FR) 0507810

(51) Int. Cl. B23K 9/28

(52) U.S. Cl. 219/137.51

(57) ABSTRACT

The invention concerns a cable casing for the guidance of a wire (2), in particular a welding wire, that includes:

a series of supports of a first type (10₁) for first guidance assemblies (11₁) for the wire, with each including roller devices (23₁),

a series of supports of a second type (10₂) for second guidance assemblies (11₂) for the wire, with each including roller devices (23₂), and with the supports of the second guidance assemblies being positioned alternately with the supports of the first guidance assemblies,

and, for each support of a type framed by supports upstream and downstream of another type, first articulation means (15) in at least one direction of articulation (A) between a support of one type with the upstream support of another type, and second articulation means, between the said support of one type with the downstream support of another type.

This present invention concerns the technical field relating to the leading or conveyance of a wire, of any nature and section, from the location of its pack to a place of use.

The subject of the invention more precisely concerns a new cable casing within which runs the wire to be conveyed between the packing location and the place of use.

The subject of the invention finds a preferred application in the conveyance of a welding wire, through the need to move it to the welding zone and the need to protect it against external aggression (dust, dirt, etc.).

In the preferred field of application, we are familiar with the use of a flexible plastic pipe inside which the welding wire travels between its packing unit (reel, drum, cask, coil, etc.) and the welding zone. The motion of the wire is driven by one or more motor-driven roller systems. Depending on the application, manual or automated welding, and the lengths of the cable casing, the motorised drive system or systems will be positioned at different places on the trajectory of the wire.

In general, it should be considered that the continuous conveyance of a welding wire gives rise to some real difficulties due, in particular, to the length of the cable casing, of the curvature assumed by the cable casing during the welding operations, the tension of the wire, and the coefficient of friction between the cable casing and the wire. It should be noted that the problem of friction changes over time, becoming more serious and generating juddering in the progress of the wire, caused by wear of the cable casing and the formation of waste swarf. In certain cases, the wire within the cable casing seizes up completely. It thus appears necessary to plan for frequent replacement of the cable casing, giving rise to additional cost due to the replacement of the cable casing and shutting down of the welding station. Furthermore, the difficulties of advancing the wire frequently leads to defects in the weld quality, resulting in additional costs, either to repair the fault, of for scrapping of the welded parts. Another constraint is associated with the fact that the length of the cable casing must be relatively small in order to cope with the problems of wear, to the extent that such a constraint limits the design options of the machine that includes such a cable casing.

In the field of cable laying, we are familiar, from document JP 9191520, with a guidance unit for a cable that includes a guidance surface projecting from which there is a wheel that is able to rotate. This document does not provide a solution to the problem of guiding a welding wire inside a cable casing that is subjected to stresses that give rise to curvatures in different directions.

Likewise, patent U.S. Pat. No. 1,898,060 described a welding machine with two roller systems mounted perpendicular to each other in order to straighten the welding wire before it is used. This patent does not provide a solution to the problem of guiding a welding wire between its pack location and its place of use.

The objective of this present invention is therefore to remedy the drawbacks mentioned above by proposing a cable casing for the guidance of a wire, designed to reduce the friction of the wire within the cable casing, even when the latter is curved in different directions.

The purpose of the invention is also to propose a cable casing for the guidance of a wire, that is intended to be of simple design, while still performing its function of guiding the wire.

In order to attain such an objective, the cable casing of the invention is characterised in that it includes:

a series of supports of a first type for the first guidance assemblies of the wire, with each including roller devices mounted facing each other to form between them a part of the guidance path of the wire, with each roller device being mounted to rotate freely on an axle carried by a support,

a series of supports of a second type for second guidance assemblies of the wire, each of which includes roller devices being mounted, firstly, facing each other to form between them a part of the guidance path of the wire and, secondly, with each being free to rotate on an axle carried by the support, with at least one of the axes of a roller device of the second guidance assemblies lying in a direction that is different from that of at least one axis of a roller device of the first guidance assemblies, and with the supports of the second guidance assemblies being positioned alternately with the supports of the first guidance assemblies,

and, for each support of a type that is framed by supports upstream and downstream of another type, first articulation means in at least one direction of articulation between a support of one type with the support upstream of another type, and second means of articulation, between the said support of one type with the support downstream of another type, in at least one direction of articulation that is different from the direction of articulation between the said support and the support upstream.

In an advantageous manner, the first and the second articulation means are implemented by an articulation of the same type, namely of the pivot, swivel or elastic type.

According to a preferred implementation variant, at least one of the axes of a roller device of the second guidance assemblies lies in a direction perpendicular to that of at least one axis of a roller device of the first guidance assemblies, and in that the first and second means of articulation have directions of articulation that are at least perpendicular to each other.

As an example, the axes of the roller devices, forming part of a given guidance assembly, are parallel to each other.

According to one implementation characteristic that aims to simplify the creation of the supports, the supports of a first type of the first guidance assemblies are identical to the supports of a second type of the second guidance assemblies.

Advantageously, each support of the guidance assemblies is equipped with a guidance tube for the wire, extending between the guidance assembly carried by the said support and the guidance assembly carried by the support upstream or downstream.

The guidance cable casing of the invention preferably includes travel-limiting means that can be used to limit the amplitude of articulation of the first and second articulation means.

Given the installation ambience of the guidance cable casing according to the invention, the latter includes a protective envelope in which the supports of the first and second guidance assemblies are mounted.

Advantageously, the protective envelope includes a spring.

Another objective of the invention is to propose a system for the advancement of a wire using means to drive it that include a guidance cable casing according to the invention, placed between the storage location of the wire and the place of use of the wire.

Miscellaneous other characteristics will emerge from the description that follows, given with reference to the appended drawings which show, by way of non-limiting examples, embodiments of the subject of the invention.

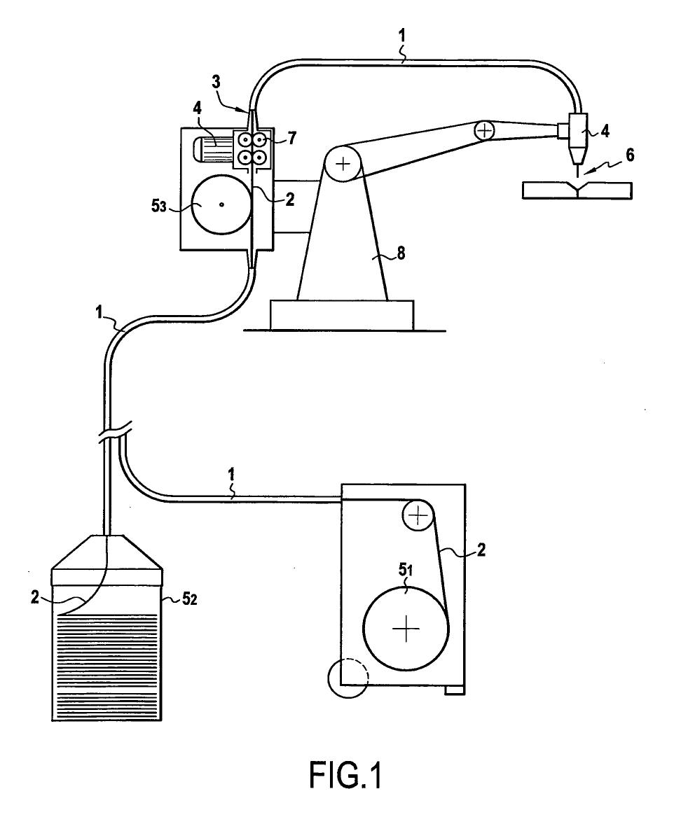

FIG. 1 is a schematic view of one example of use of a cable casing according to the invention.

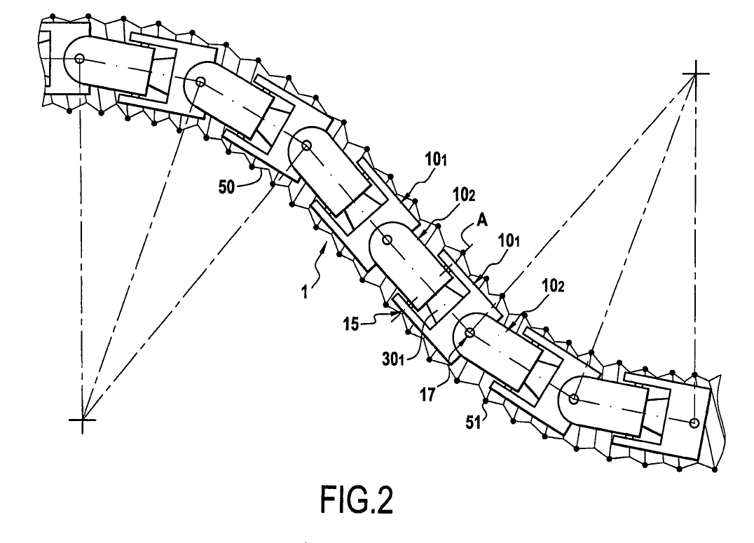

FIG. 2 is a partial view of an implementation example of a cable casing according to the invention.

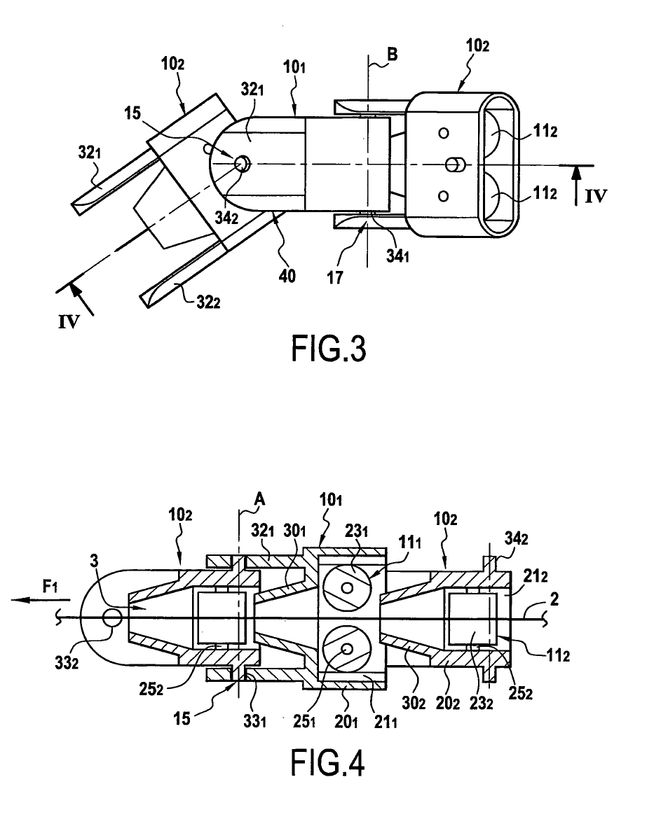

FIG. 3 is a view in perspective of a section of cable casing, as illustrated in FIG. 2.

FIG. 4 is a view, in section, taken more-or-less along lines IV-IV of FIG. 3.

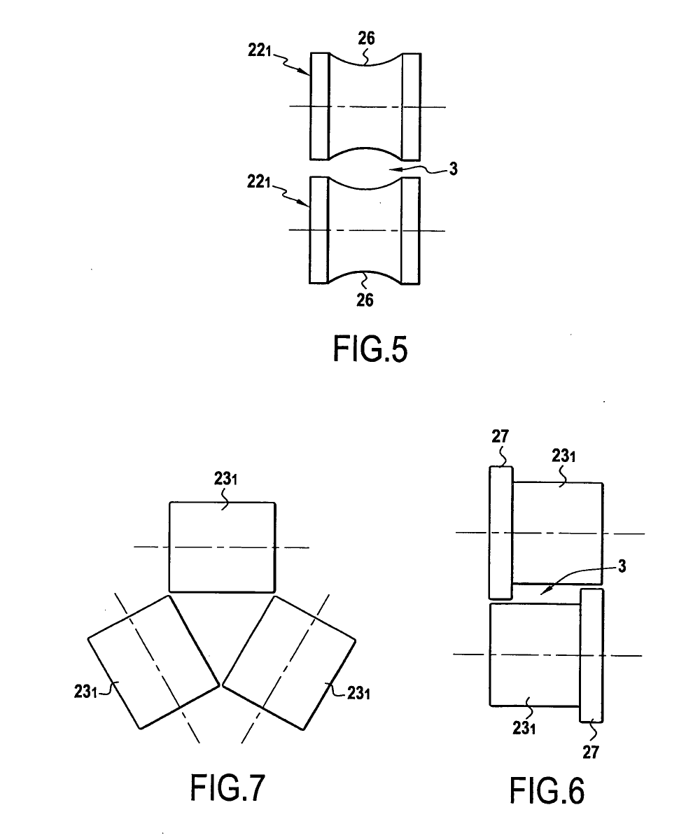

FIGS. 5 to 7 are examples of implementation of the guidance assembly according to the invention.

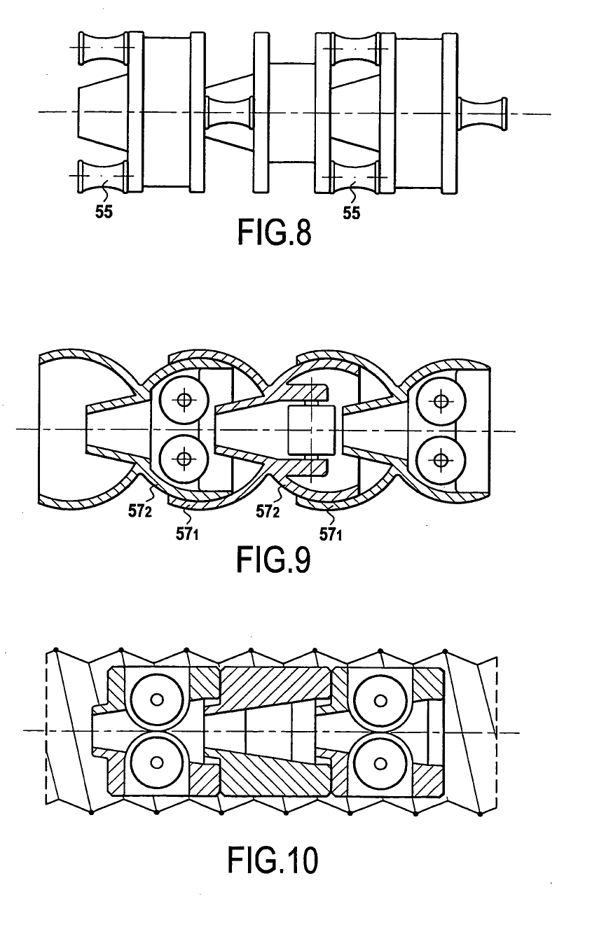

FIGS. 8 to 10 illustrate other implementation variants of the cable casing according to the invention.

As can be seen more precisely from FIG. 1, the subject of the invention is a cable casing 1 that provides guidance for a wire 2 moving inside a cable casing on a guidance path 3, in a direction of movement as indicated by arrow F₁. The cable casing 1 according to the invention is used with at least one movement system 4 that can be used to convey the wire 2 from a storage or conditioning location 5₁, 5₂ or 5₃ to an area of use 6. The movement system 4 includes means 7 for driving the wire, of any type that is known in itself, such as of the push, pull, push-pull or push-push type. The driving means 7 will not be described with any greater precision since they do not form part of the subject of the invention and are already well known to those skilled in the art.

The wire 2 can be either solid or hollow, and has a section that can be circular or any other shape, for example. The wire 2 is packed in different ways, such as in a drum 5₁, a coil, a cask 5₂ or a reel 5₃, as illustrated in FIG. 1. According to a preferred form of application, the wire 2 is a welding wire that is guided within the cable casing 1 according to the invention, in order to be conveyed to a position of use 6, such as a welding station associated with a robot 8. The cable casing 1 according to the invention can thus be used between the welding station 6 and the movement system 4, close to which the reel 5₃ is placed in the example illustrated, or between the welding station 6 and a remote packing unit such as cask 5₂ or a drum 5₁, for example.

FIGS. 2 to 4 illustrate a first implementation variant of a cable casing 1 according to the invention that includes a series of supports of the first type 10₁, for the first guidance assemblies 11₁, for wire 2, and a series of supports of a second type 10₂ for the second guidance assemblies 11₂ for the wire. The supports of the first type 10₁ and the supports of the second type 10₂ are positioned, successively and alternately, so that outside of the supports forming the two ends of the cable casing, a support of one given type is interleaved with two supports of a different type.

For reasons of clarity, it will be considered that a support of one given type is adjacent or close, on any of its sides, to a support of a different type, called the upstream type, with reference to the direction of travel of the wire and, on its other side, to a different support, called the downstream support.

According to another characteristic of the invention, each support of one type 10₁, 10₂ is articulated with each of the nearby or adjacent supports of a different type. Thus, with the exception of supports that delimit each end of the cable casing, each support of a given type, for example of first type 10₁, is articulated, firstly, using first articulation means 15 with the support downstream of the second type 10₂, in at least one direction of articulation A and, secondly, using second articulation means 17, with the support upstream of the second type 10₂, in at least one direction of articulation B that is different from direction of articulation A. In like manner, each support of a second type 10₂ is articulated firstly, using the first articulation means 15 with the upstream support of first type 10₁, in at least one direction of articulation A and, secondly, using second articulation means 17 with the downstream support of the first type 10₁ in at least one direction of articulation B.

Advantageously, the articulation means 15, 17 are designed to enable a relative movement of the supports in at least two directions of articulation A, B perpendicular to each other, so that the cable casing is able to follow curvatures lying in different planes. According to one implementation characteristic, which is illustrated more precisely in FIGS. 2 to 4, in the remainder of the description, the directions of articulation A and B are perpendicular to each other and to the direction of travel of the wire 2.

According to an advantageous implementation characteristic, the supports of the first type 10₁, are identical to the supports of the second type 10₂. In the example considered, the supports of the first type 10₁, are offset by an angle, along the axis of the cable casing, by 90° in relation to the supports of a second type 10₂. In the remainder of the description, indices 1 and 2 of the different elements making up the supports will be associated respectively with the supports of the first type 10₁ and the supports of the second type 10₂.

Each support 10₁, 10₂ comes in the form of a tubular or annular body 20₁, 20₂ delimiting, on the inside, a mounting cage 21₁, 21₂ for a guidance assembly 11₁, 11₂. According to the implementation variant illustrated, each guidance assembly 11₁, 11₂ includes roller devices 23₁, 23₂, mounted facing each other so as to form the guidance path 3 for the wire 2. Each roller device 23₁, 23₂ is mounted to rotate freely on an axis 25₁, 25₂ carried by the support 10₁, 10₂. In the example illustrated in FIGS. 3 and 4, each guidance assembly 11₁, 11₂ includes two roller devices 23₁, 232 carried by axes that lie parallel to each other. Each roller device 23₁, 23₂, can be implemented by a roller or a wheel with a constant circular straight cross section, as illustrated in FIG. 4, with or without a channel 26, as illustrated in FIG. 5, or with a lateral retaining rib 27, as illustrated in FIG. 6. Likewise, it should be noted that each guidance assembly 11₁, 11₂ can include a number of roller devices other than two, such as three devices whose axes are offset in relation to each other by 120° to constitute a guidance path 3 of triangular section, as illustrated in FIG. 7.

The separation of the roller devices 23₁, 23₂, placed opposite to each other in order to constitute a guidance assembly, is chosen so that the guidance path 3 has a passage section that is greater than the diameter of the wire. This passage section is chosen to advantageously allow the passage of wires of different diameters. It should be considered that wire 2 can thus pass freely in the parts of the cable casing that are rectilinear or straight, while wire 2 is in contact with the roller devices located in the parts of the cable casing that are subjected to a curvature.

Each body 20₁, 20₂ is extended advantageously, opposite to the mounting cage 21₁, 21₂, by a guidance tube 30₁, 30₂ for the wire, thus forming the guidance path 3 for the wire. Each guidance tube 30₁, 30₂ thus lies between the guidance assembly 11₁, 11₂ carried by the said corresponding support and the guidance assembly carried by the downstream support. In other words, each guidance tube 30₁, 30₂ provides guidance continuity for the wire between two nearby or consecutive guidance assemblies 11₁, 11₂ carried by two supports of different types. Each guidance tube 30₁, 30₂ preferably, has a longitudinal section of tapered form which reduces in the direction of the downstream support.

Each body 20₁, 20₂ is also equipped with two arms 32₁, 32₂, lying parallel to each other and on either side of the guidance tube 30₁, 30₂. The two arms 32₁, 32₂ are each equipped with a reception orifice 33₁, 33₂ respectively for a pivot 34₂, 34₁, created on the body 20₁, 20₂. The two reception orifices 33₁ of a support are aligned, and are designed to receive the two pivots 34₂ of a downstream support that can be used to form the first articulation means 15, while the two pivots 34₁ of the said support with which the two orifices 33₂ of an upstream support mate, form the second articulation means 17. Naturally, the position of the reception orifices 33₁, 33₂ on the supports can be reversed with the position of the pivots 34₁, 34₂.

Advantageously, it follows that each articulation A, B is located in the vicinity of a guidance assembly 11₁, 11₂. Each articulation A, B, near to a guidance assembly, preferably lies substantially parallel to the axis of at least one roller device belonging to the said guidance assembly. Thus, as can be seen more precisely in FIG. 4, the articulation means 15, for example, has a direction of articulation A that is parallel and close to the axes 25₂ of the nearby roller devices while the articulation means 17 have a direction of articulation B that is parallel and close to the axes 25₁ of the nearby roller devices.

According to another characteristic of the invention, the cable casing 1 includes travel-limiting means 40 designed to limit the amplitude of the first 15 and the second 17 articulation means. In the example illustrated, the limiting means 40 are formed by the guidance tube 30₁, 30₂ of a support, designed to butt up against the body of a neighbouring support. For example, the alignment offset between two consecutive supports can be limited to a value of the order of 30°.

It emerges from the foregoing description that the cable casing 1 according to the invention is used to guide the wire 2 during its travel by means, in particular, of the roller devices 23₁, 23₂. The resistance to the advance of the wire is due solely to the friction of the roller device on its axle. The guidance of the wire 2 is thus guaranteed, even if the cable casing is subjected to movement, in particular at its place of use, giving rise to the changes of curvature in different planes. In fact the implementation of the articulation means 15, 17 in two different planes, alternating from one support to the other, enables the cable casing to follow different configurations.

According to a preferred implementation characteristic, the support assembly 10₁, 10₂ can be mounted inside of a protective envelope 50, as illustrated in FIG. 2. This protective envelope 50 can possibly be associated with a helical spring 51 which, in the example illustrated, is directly incorporated into the protective envelope. Such a spring 51 endows the cable casing with a particular stiffness that also contributes to ensuring the relative alignment of the supports with each other.

Naturally, the articulation means 15, 17 can be achieved in a manner that is different from a pivot-type articulation. Each pivot articulation can be replaced by an elastic link that employs one or more springs or elastic elements 55, as illustrated in FIG. 8, interposed between the supports 10₁, 10₂.

Likewise, supports 10₁ and 10₂ can be connected together by articulation means, of the swivel type, as illustrated in FIG. 9. According to this implementation variant, each support body 20₁, 20₂ thus includes, on either side, a hemispherical part respectively 57₁, 57₂ each mating with a hemispherical part that is complementary and opposite 57₂, 57₁ to a neighbouring support. Each support is therefore assembled to each neighbouring support, by a swivel articulation that enables a relative angular movement of the supports in different directions.

According to another implementation variant, illustrated in FIG. 10, it can be arranged that the supports 10₁, 10₂ are mounted without any mechanical link between them, but being mounted within a cable casing 50 in which are mounted the supports mating together by conformations 60₁, 60₂, arranged on the supports and mating with each other to create an articulation between two consecutive or nearby supports. The invention is not limited to the examples described and represented here, since various changes can be made to it without moving outside of its scope.

1. A cable casing for the guidance of a wire (2) moving with a given direction of motion in a guidance path (3) created within the cable casing, characterised in that it includes:
a series of supports of a first type (10₁) for first guidance assemblies (11₁) for the wire, with each including roller devices (23₁) mounted facing each other to form between them a part of the guidance path of the wire, and with each roller device being mounted to rotate freely on an axis (25₁) carried by a support,
a series of supports of a second type (10₂) for second guidance assemblies (11₂) for the wire, each including roller devices (23₂) mounted, firstly, facing each other to form between them a part of the guidance path of the wire, and secondly, each free to rotate on an axis (25₂) carried by the support, at least one of the axes of a roller device of the second guidance assemblies lying in a direction that is different from that of at least one axis of a roller device of the first guidance assemblies, the supports of the second guidance assemblies being positioned alternately with the supports of the first guidance assemblies,
and, for each support of a type framed by supports upstream and downstream of another type, first articulation means (15) in at least one direction of articulation (A) between a support of one type with the upstream support of another type, and second articulation means (17) between the said support of one type with the downstream support of another type, in at least one direction of articulation that is different from the direction of articulation (B) between the said support and the upstream support.

2. A guidance cable casing according to claim 1, characterised in that the first (15) and the second (17) articulation means are created by an articulation of the same type, such as of the pivot, swivel or elastic type.

3. A guidance cable casing according to claim 1, characterised in that at least one of the axes of a roller device (23₁, 23₂) of the second guidance assemblies (11₂) lies in a direction perpendicular to that of at least one axis of a roller device of the first guidance assemblies (11₁), and in that the first (15) and second (17) articulation means have directions of articulation that are at least perpendicular to each other.

4. A guidance cable casing according to claim 3, characterised in that the axes (25₁, 25₂) of the roller devices, forming part of a given guidance assembly, are parallel to each other.

5. A guidance cable casing according to claim 1, characterised in that the supports of first type (10₁) of the first guidance assemblies (11₁) are identical to the supports (10₂) of a second type of the second guidance assemblies (11₂).

6. A guidance cable casing according to claim 5, characterised in that each support (10₁, 10₂) of the guidance assemblies is equipped with a guidance tube (30₁, 30₂) for the wire (2) lying between the guidance assembly carried by the said support and the guidance assembly carried by the support downstream or upstream.

7. A guidance cable casing according to any of claim 1, characterised in that it includes travel-limiting means (40) that can be used to limit the amplitude of articulation of the first and the second articulation means.

8. A guidance cable casing according to any of claim 1, characterised in that it includes a protective envelope (50) in which the supports (10₁, 10₂) of the first and second guidance assemblies are mounted.

9. A guidance cable casing according to claim 8, characterised in that the protective envelope (50) includes a spring (51).

10. A movement system for a wire, using driving means, characterised in that it includes a guidance cable casing (1) for the wire (2), according to claim 1, positioned between the storage location of the wire and the place of use of the wire.
